(19) United States
(12) Patent Application Publication
(10) Pub. No.: US 2008/0080163 A1
(43) Pub. Date: Apr. 3, 2008

(54) Illuminated devices utilizing light active sheet material with integrated light emitting diode (LED), methods of producing illuminated devices, and kits therefor

(75) Inventors: William Dominic Grote III, Madison, IN (US); Arturo M. Hernandez, Madison, IN (US); Stanley D. Robbins, Deputy, IN (US)

Correspondence Address: POSZ LAW GROUP, PLC, 12040 SOUTH LAKES DRIVE, SUITE 101, RESTON, VA, 20191, US

(73) Assignee: Grote Industries, Inc., Madison, IN (US)

(21) Appl. No.: 11/902,981

(22) Filed: Sep. 27, 2007

Related U.S. Application Data
(60) Provisional application No. 60/847,935, filed on Sep. 29, 2006.
(60) Provisional application No. 60/847,917, filed on Sep. 29, 2006.

(51) Int. Cl. G01D 11/28

(52) U.S. Cl. 362/23

(57) ABSTRACT

An illuminated push button, an illuminated instrument cluster for a conveyance, and a lighting system for a conveyance are discussed. The push button can include a light sheet mounted on a base portion, such that light from the LED chips in the light sheet travels away from the base portion. The illuminated instrument cluster can include a lens mask assembly; an appliqué disposed behind the lens mask assembly with translucent graphical information and optically transmissive diffusion material, a housing, a light sheet, and a printed circuit board configured to address and drive the light sheet material. The light active sheet material is mounted behind the appliqué, such that light from the LED chips travels through the graphical information of the appliqué. The lighting system includes a light sheet; and an adhesive disposed on the light sheet. The light active sheet material is formed as lighting for a conveyance.

### CROSS-REFERENCE TO RELATED APPLICATIONS

This application claims the benefit of the U.S. Provisional Application No. 60/847,935 filed Sep. 29, 2006; and U.S. Provisional Application No. 60/847,917 filed Sep. 29, 2006, all of which are expressly incorporated herein by reference.

### TECHNICAL FIELD

The technical field relates in general to light sources, and more specifically to various interior or exterior light sources utilizing light active sheet material, for conveyances such as vehicles.

### BACKGROUND

In the vehicle lighting industry, illumination can be achieved through the use of various light sources, all of which require complex manufacturing processes or complex methods of excitation.

For example, an incandescent bulb consists of a filament light source packaged inside a glass bulb. The bulb must be evacuated of air and filled with a gas. The entire envelope must be sealed. These types of light sources typically fail after a short life due to filament breakage. Furthermore, since the light source is formed from glass, the handling and mounting of the light source is a delicate procedure and breakage is common.

Similarly, gas discharge lamps, such as high intensity discharge and fluorescent, may contain undesirable materials such as mercury. As with incandescent bulbs, a glass envelope must be formed, evacuated, filled and sealed, leading to a high processing cost. These types of lamps typically require complex electronics to excite the gases in order to extract light from the tube. In addition, because the light source is formed from glass, the handling and mounting of the light source is delicate and breakage is common. Thus, to create a finished, useable lamp, the light source must be carefully packaged and the electronics designed to have proper operation in a vehicle environment.

Electroluminescent lighting, on the other hand, typically lends itself to simple processing methods. However, it requires a high voltage at a frequency that can interfere with other electrical components through electromagnetic interference.

Light emitting diodes (LEDs), such as illustrated in FIG. 18, typically require a die bond, a wire bond and a molding operation to create an LED component. This part can then be manufactured into a printed circuit board with additional components to protect and bias the LED. A finished lamp may then use a lens and a body to direct the light and support the circuit board, respectively.

Most of these types of illumination require a certain distance from the point of illumination in order to be effective, as in vehicle signal lamps, push button lighting, and instrument cluster illumination.

### SUMMARY

Accordingly, one or more embodiments provide an illuminated push button. The illuminated push button can include a light active sheet material, and a base portion. The light active sheet material can include a transparent electrically conductive top substrate; a pattern of one or more light emitting diode (LED) chips sandwiched between a bottom substrate and the top substrate; and a non-conductive transparent adhesive material disposed between the bottom substrate, the LED chips, and the first top substrate. The LED chips are preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the bottom substrate. The light active sheet material is mounted on the base portion, the top substrate facing away from the base portion, such that light from the at least one LED chip travels away from the base portion.

One or more other embodiments provide an illuminated instrument cluster for a conveyance. The illuminated instrument cluster can include a lens mask assembly; an appliqué disposed behind the lens mask assembly, having translucent graphical information and an optically transmissive diffusion material adhered to a side disposed away from a driver of the conveyance; a housing; a light active sheet material; and a printed circuit board configured to address and drive the light active sheet material, mounted behind the light active sheet material. The light active sheet material can include a transparent electrically conductive top substrate; a pattern of light emitting diode (LED) chips sandwiched between a bottom substrate and the top substrate; and a non-conductive transparent adhesive material disposed between the bottom substrate, the LED chips, and the first top substrate. The LED chips can be preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the bottom substrate. The light active sheet material is mounted behind the appliqué, the top substrate facing toward the appliqué, such that light from the LED chips travels through the graphical information of the appliqué. The lens mask assembly, the appliqué, the light active sheet material, and the printed circuit board are mounted in the housing in that order.

One or more further embodiments provide a lighting system for a conveyance. The lighting system includes a light active sheet material, and an adhesive disposed on the light active sheet material. The light active sheet material includes top and bottom electrically conductive substrates, and a pattern of light emitting diode (LED) chips sandwiched between the electrically conductive substrates. The top electrically conductive substrate is transparent; the LED chips are preformed before being patterned in the light active sheet material as an unpackaged discrete semiconductor device having an anode p-junction side and a cathode n-junction side; either of the anode and the cathode side is in electrical communication with one of the electrically conductive substrates and the other of the anode and the cathode side is in electrical communication with the other of the electrically conductive substrates. The light active sheet material is formed as lighting for a conveyance.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a cross sectional diagram illustrating a light sheet with light emitting diodes biased opposite of each other in series;

FIG. 2 is a schematic diagram corresponding to FIG. 1;

FIG. 3A to FIG. 3E are cross sectional diagrams illustrating a method of producing the light sheet according to FIG. 1;

FIG. 4 is a cross sectional diagram illustrating a light sheet with light emitting diodes biased opposite of each other in parallel;

FIG. 5 is a schematic diagram corresponding to FIG. 4;

FIG. 6A to FIG. 6E are cross sectional diagrams illustrating a method of producing the light sheet according to FIG. 4;

FIG. 7 is an exploded view of a lamp with a light sheet assembled on a lamp housing;

FIG. 8 is an exploded view of a lamp with a light sheet assembled on a back of a lens;

FIG. 9 is a cross section of a backlit push button;

FIG. 10 is a partial cross section of another backlit push button;

FIG. 11 is a side view of a backlit instrument cluster;

FIG. 12 is an exploded view of a backlit instrument cluster;

FIG. 13 is a front view of an illuminated license plate frame;

FIG. 14 is a partial side view of FIG. 13;

FIG. 15 is a partial cross section of FIG. 13;

FIG. 16 illustrates various configurations of a light sheet applied directly to an automobile;

FIG. 17 illustrates a kit for use in connection with applying a light sheet to a conveyance; and

FIG. 18 is a schematic of a prior art light emitting diode lamp.

### DETAILED DESCRIPTION

In overview, the present disclosure concerns illuminated devices provided with a light active sheet material, where light emitting diode (LED) chips are integral to the light active sheet material. Such an illuminated device can utilize the light active sheet material, sometimes referred to as “light sheet,” which can reduce the profile of the illuminated device because the light sheet with integrated LED chips is flat, thin, and flexible. Moreover, a light sheet does not require housings or hard lenses than can be damaged or cracked. The thin characteristic and flexibility of the light sheet can be exploited to provide illuminated devices in various forms for accent, safety, or cosmetic purposes, including without limitation flat lighting on surfaces, and/or lighting bent to conform to the shapes of surfaces. Examples of illuminated devices include interior illumination and exterior illumination such as backlighting, courtesy lamps, marker lamps, dome lamps, high mount stop lamp (HMSL), headlamps, fog lamps, stop/tail/turn (STT) lights, front/park/turn (FPT) lights, variants, and the like, used in connection with conveyances. More particularly, various inventive concepts and principles are embodied in systems, devices, and methods therein for providing an integrated LED illuminated device utilizing light active sheet material.

The conveyances of particular interest include automobiles, trucks, motorized vehicles, trains, trailers, air craft, water craft, heavy machinery used for regulated or non-regulated industries such as agricultural, lawn care, mining, snow blowing, and the like, and variants or evolutions thereof.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

As further discussed herein below, various inventive principles and combinations thereof are advantageously employed to simplify the process of manufacturing light sources, to reduce breakage of lamps, to provide easier handling and mounting of light sources, where the light sources are operable in connection with a conveyance.

Further in accordance with exemplary embodiments, illuminated devices are provided utilizing light active sheet material, for use in conveyances. Such light active sheet material is not only simple to manufacture, but also has circuit elements integrated into the substrate forming the light active sheet material that provide proper biasing of the LED chips, as follows. A transparent conductor used in the light active sheet material has a resistive characteristic. The LED chip can be disposed such that a set, known resistance is in series with the LED chip. This resistance permits the current to be set through the LED chip, for example instead of the discrete resistor now soldered into a circuit board used with conventional LED lamps.

LED chips have a characteristic of clamping the forward voltage to approximately 2 to 4 volts, depending on the material of the LED chip. LED chips can also handle a reverse voltage of 5 volts or less. Using these characteristics, one LED chip may protect another from the detrimental effects of reverse voltage.

A combination of the transparent conductor resistance and two parallel LED chips placed opposite in polarity can provide a lamp with the same bias and protection now found in conventional lamps, but all processed in a continuous cell process. The utilization of light active sheet material can provide a lamp with the advantages of reduced LED piece cost and reduced processing cost.

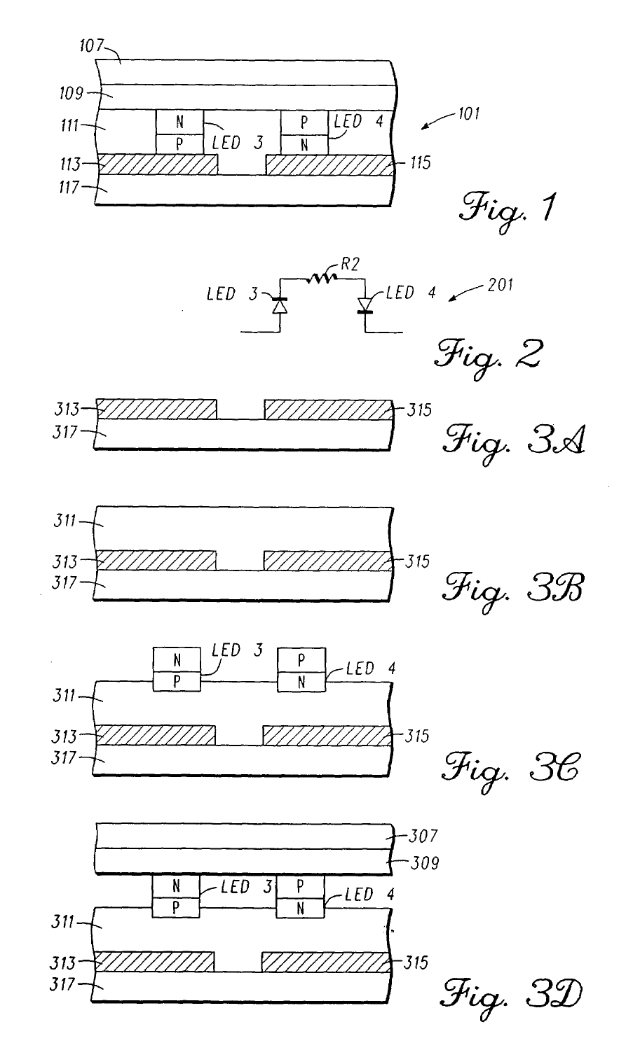

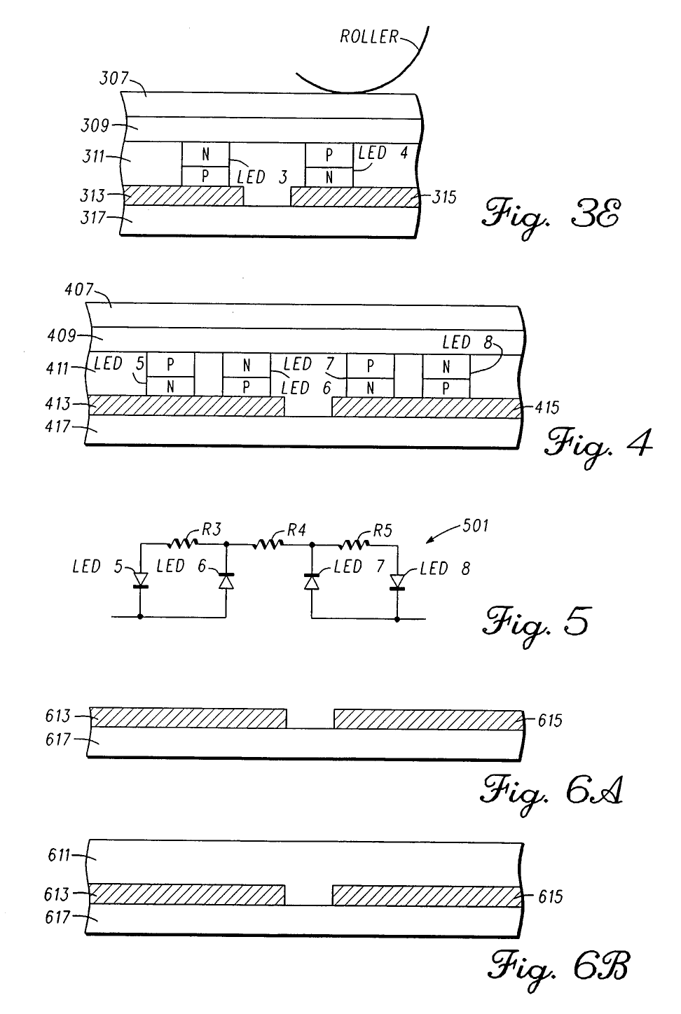

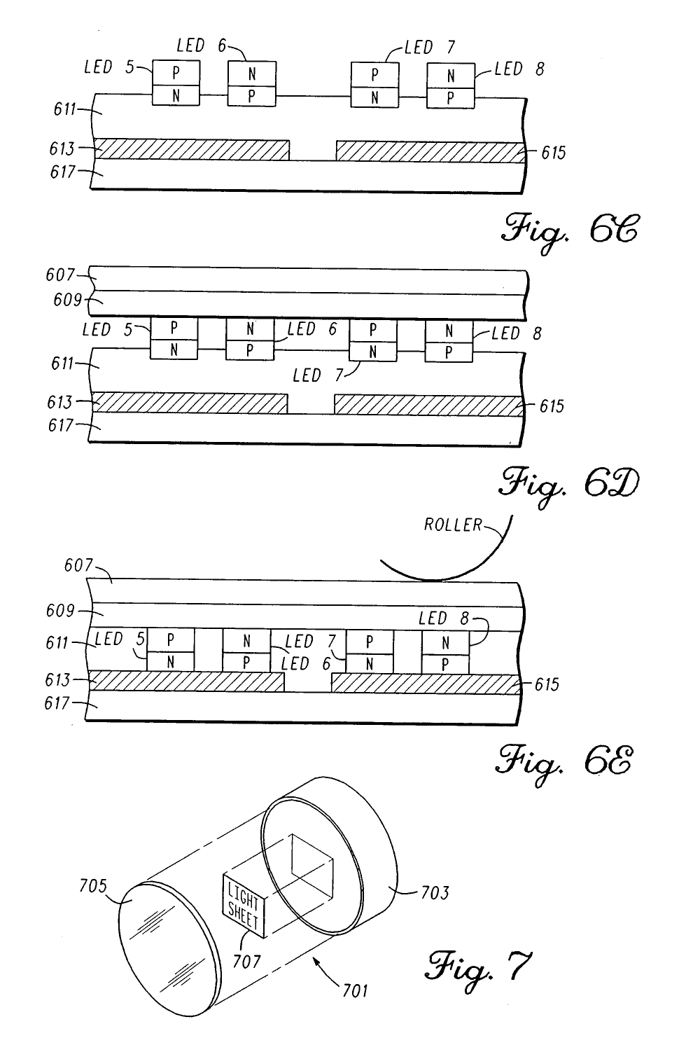

FIG. 1, FIG. 2, and FIG. 3A to FIG. 3E provide an illustration of a light active sheet material with LED chips biased opposite of each other, in series, and a method of producing such light active sheet material. In FIG. 4, FIG. 5, and FIG. 6A to FIG. 6E, the light active sheet material includes LED chips biased opposite of each other, but in parallel. Either light active sheet material is appropriate for use in various applications, including those illustrated in FIG. 7 to FIG. 18. Other light active sheet materials with integrated LED chips also are discussed in U.S. Pat. No. 7,217,956, for example, and can be used in applications discussed in connection with FIG. 7 to FIG. 18 below.

Referring now to FIG. 1, a cross sectional diagram illustrating a light sheet with light emitting diodes biased opposite of each other in series will be discussed and described. A light active sheet material 101 includes a first top substrate 109, a second top substrate 107, a bottom substrate 117, conductors (here represented by conductors 113, 115), light emitting diode (LED) chips (here represented by LED chip 3 and LED chip 4), and adhesive 111.

The second top substrate 107 is disposed as a top layer of the light sheet. The “top” of the light sheet is used to indicate an area toward which light from the LED chips (such as LED chips 3, 4) will shine, and a “bottom” indicates the side of the light sheet which is opposite to the top site. Accordingly, the second top substrate 107 can be formed of a transparent or translucent material. The material of the second top substrate 107 advantageously can be flexible. Appropriate materials for use as the second top substrate 107 include transparent or translucent plastics, for example, polymers such as polyethylene terephthalate (PET) and polyethylene 2,6 naphthalene dicarboxylate (PEN), and variations and/or blends thereof.

The first top substrate 109 is disposed onto the second top substrate 107 prior to assembly of the light sheet. Electrically, the first top substrate 109 is below the second top substrate 107, and is in electrical contact with the LED chips 3, 4. As illustrated, the electrical contact between the first top substrate 109 and the LED chips 3, 4 is direct. Also, the light from the LED chips 3, 4 will shine through the first top substrate 109. Accordingly, the first top substrate 109 can be formed of an electrically conductive material which is also optically transparent or translucent. An appropriate material is a conducting metal oxide, for example an indium tin oxide (ITO) film (as illustrated), a carbon nanotube conductive film, an aluminum-doped zinc oxide film, and/or a conductive polymer layer such as PEDOT:PSS (poly(3,4-ethylenedioxythiophene)poly(styrenesulfonate)) and/or PEDOT (poly(3,4-ethylenedioxythiophene)) available from, for example, Agfa or H.C. Starck.

Each of the LED chips 3, 4 has a p-side and an n-side and/or light-to-energy semiconductor layered particles, wherein the n-side and the p-side correspond to charge donor and charge acceptor layers. The LED chips 3, 4 are oriented to be driven with opposite polarity electrical energy. The LED chips 3, 4 are in electrical contact with the first top substrate 109 as well as respective conductors 113, 115 disposed below the LED chips 3, 4. Appropriate LED chips are widely available commercially. The LED chips 3, 4 are patterned on the conductors, as further described below.

The conductors (here represented by conductors 113, 115), are formed of a conductive material, for example, conductive adhesive, conductive screen print, conductive film, or conductive wire. The conductors 113, 115 may be deposited on the bottom substrate 117 using various methods, such as film deposition, etching, printing, or other variations. The bottom substrate 117 can be formed of a flexible non-conductive material, for example, a polymer, FR-4 (Flame Resistant 4 (fiberglass-resin)), CEM-1 (Composite Epoxy Material 1 (fiberglass-cellulose-resin)); or any non-conductive material.

The adhesive 111 is disposed to fill gaps between the patterned LED chips, gaps between the first top substrate 109 and the conductors 113, 115, and gaps between the first top substrate 109 and the bottom substrate 117. The adhesive 111 also mechanically holds the first top substrate 109, the conductors 113, 115, and the bottom substrate 117 together. The adhesive 111 electrically isolates the first top substrate 109 from the conductors 113, 115, and therefore can be formed of a non-conductive adhesive material. Optionally, the adhesive 111 further can be transparent.

The conductors 113, 115 are of opposite polarity, and are located below the LED chips 3, 4 are biased opposite of each other in series, and spaced apart from each other so that a gap is formed between the conductors. As will be described below in more detail, the conductors 113, 115 may be connected to a power source. In this configuration, a resistor (R2) is formed between the two LED chips 3, 4 by the first top substrate 109.

Although only two LED chips are illustrated, additional LED chips can be added and connected in series using the above principles, as will be appreciated by one of ordinary skill in the art.

Referring now to FIG. 2, a schematic diagram 201 corresponding to FIG. 1 will be discussed and described. The LED chips 3, 4 are biased opposite of each other and connected in series. The LED chips 3, 4 are connected to each other through a resistor R2. The resistor R2 is formed by the resistive properties of the first top substrate 109.

Accordingly, a light active sheet material can include a first top substrate, wherein the first top substrate is transparent and electrically conductive; a second top substrate, wherein the second top substrate is transparent, wherein the second top substrate is disposed in contact with the first top substrate; a bottom substrate; a pattern of conductors patterned on the bottom substrate; a pattern of light emitting diode (LED) chips disposed between the first top substrate on a side opposite to the second top substrate, and the bottom substrate on a side with the pattern of conductors; and a non-conductive transparent adhesive material disposed between the bottom substrate, the LED chips, and the first top substrate. The LED chips can be preformed before being patterned in the light active sheet material as an unpackaged discrete semiconductor device having an anode p-junction side and a cathode n-junction side. Either of the anode and the cathode side is in electrical communication with the first top substrate and the other of the anode and the cathode side is in electrical communication with the pattern of conductors. The conductors in the pattern of conductors can be spaced apart.

Moreover, in the light active sheet material, the pattern of LED chips can include two or more LED chips electrically connected in series, wherein adjacent connected LED chips are biased opposite of each other.

Furthermore, in the light active sheet material, a first portion of the pattern of conductors below and in electrical communication with one of the LED chips can be spaced apart from a second portion of the pattern of conductors below and in electrical communication with the other of the at least two LED chips which are electrically connected in parallel.

Accordingly, there is also a method of providing a conveyance with a lighting system. The method can include providing such a lighting system, mounting the lighting system on the conveyance, and electrically connecting the lighting system to an electrical wiring harness of the conveyance.

Referring now to FIG. 3A to FIG. 3E, cross sectional diagrams illustrating a method of producing the light sheet according to FIG. 1 will be discussed and described. In FIG. 3A, conductors 313, 315 are disposed on a bottom substrate 317. The conductor has a pattern corresponding to locations where LED chips will be patterned. Appropriate methods for providing the conductors 313, 315 include vapor deposition and etching, screen printing, electro-plating, and the like. The conductors 313, 315 correspond to the conductors discussed in connection with FIG. 1.

In FIG. 3B, a non-conductive adhesive 311 is disposed on the bottom substrate 317 and conductors 313, 315. The adhesive 311 can be provided as a film. The adhesive corresponds to the adhesive discussed in connection with FIG. 1.

As illustrated in FIG. 3C, the LED chips 3, 4 are patterned on the adhesive 311 in a predetermined pattern so that they are positioned on top of the conductors 313, 315. Also, the predetermined pattern can correspond to a particular shape and/or color of an illuminated device for which the light sheet is to be used.

FIG. 3D illustrates an ITO layer 309, corresponding to the first top substrate discussed in FIG. 1, previously disposed on a transparent substrate 307, corresponding to the second substrate discussed in FIG. 1. Both substrates 309, 307 are disposed over the LED chips 3, 4.

As illustrated in FIG. 3E, the transparent substrate 307 and the ITO layer 309 are disposed on top of the LED chips 3, 4. A roller presses together the transparent substrate 307, the ITO layer 309, the adhesive layer 311, the LED chips 3, 4, the conductors 313, 315, and the bottom substrate. By use of pressure and/or heat, the LED chips can be sandwiched between and in electrical contact with the conductors 313, 315 and ITO layer 309. Meanwhile, the non-conductive adhesive 311 becomes distributed in the gaps between the conductors 313, the bottom substrate 317, the ITO layer 309, and the LED chips 3, 4.

Accordingly, a method for forming a light active sheet material includes providing a pattern of conductors formed on a bottom substrate; disposing a pattern of light emitting diode (LED) chips on the bottom substrate on a side with the pattern of conductors, wherein the LED chips are disposed to correspond to the conductors; disposing a non-conductive transparent adhesive material on the bottom substrate; disposing a first top substrate on the pattern of LED chips, wherein the first top substrate is transparent and electrically conductive; and disposing a second top substrate on the first top substrate, wherein the second top substrate is transparent. The LED chips can be preformed before being patterned in the light active sheet material as an unpackaged discrete semiconductor device having an anode p-junction side and a cathode n-junction side. Either of the anode and the cathode side is in electrical communication with the first top substrate and the other of the anode and the cathode side is in electrical communication with the pattern of conductors. The conductors in the pattern of conductors are spaced apart.

Moreover, in the method, the pattern of LED chips can include two or more LED chips electrically connected in parallel, wherein adjacent connected LED chips are biased opposite of each other. Further, a first portion of the pattern of conductors below and in electrical communication with one of the LED chips can be spaced apart from a second portion of the pattern of conductors below and in electrical communication with the other of the at least two LED chips which are electrically connected in parallel.

In another embodiment, the pattern of LED chips includes two or more LED chips electrically connected in series, wherein adjacent connected LED chips are biased opposite of each other. A first portion of the pattern of conductors below and in electrical communication with one of the LED chips is spaced apart from a second portion of the pattern of conductors below and in electrical communication with the other of the at least two LED chips which are electrically connected in parallel.

FIG. 4, FIG. 5, and FIG. 6A to FIG. 6E provide an illustration of a light active sheet material with LED chips biased opposite of each other, in parallel, and a method of producing such light active sheet material. (In FIG. 1, FIG. 2 and FIGS. 3A to 3E, in contrast, the LED chips were in series.) This light active sheet material also is appropriate for use in various applications, including those illustrated in FIG. 7 to FIG. 18. Various details in these figures are repetitious of details presented in the prior figures, and discussion will not be repeated for the sake of clarity.

Referring now to FIG. 4, a cross sectional diagram illustrating a light sheet with light emitting diodes biased opposite of each other in parallel will be discussed and described. A light active sheet material 401 includes a first top substrate 409, a second top substrate 407, a bottom substrate 417, conductors (here represented by conductors 413, 415), LED chips (here represented by LED chip 5, LED chip 6, LED chip 7, and LED chip 8), and adhesive 411.

The second top substrate 407 is disposed as a top layer of the light sheet. Light from the LED chips 5, 6, 7, 8 can shine through the second top substrate 407. The second top substrate 407 can be formed of a transparent or translucent material, which can be flexible. Appropriate materials for use as the second top substrate 407 include those discussed in connection with FIG. 1.

The first top substrate 409 is disposed below the second top substrate 407, and is in direct electrical contact with the LED chips 5, 6, 7, 8. Light emitted from the LED chips 5, 6, 7, 8 will shine through the first top substrate 409, and then the second top substrate 407. Thus, the first top substrate 409 can be formed of an electrically conductive material which is also optically transparent or translucent. Appropriate materials for use as the first top substrate were discussed in connection with FIG. 1.

The LED chips 5, 6, 7, 8 have a p-side and an n-side, and are oriented to be driven with opposite polarity electrical energy. The LED chips 5, 6, 7, 8 are in electrical contact with the first top substrate 409 as well as respective conductors 413, 415 disposed below the LED chips 5, 6, 7, 8. The LED chips 5, 6, 7, 8 are patterned on the conductors. Appropriate materials and methods for use in providing the conductors 413, 415 were discussed above.

The adhesive 411 is formed of a non-conductive transparent adhesive material, and can be disposed in gaps which occur between the patterned LED chips 5, 6, 7, 8, the first top substrate 409, the conductors 413, 415, and the bottom substrate 417. The adhesive can be applied as a film (illustrated) or droplets.

The conductors 413, 415 are below and in electrical contact with a first cluster of LED chips 5, 6 and a second cluster of LED chips 7, 8 which are biased opposite of each other in parallel. The conductors 413, 415 are spaced apart so that a gap is formed, the conductors 413, 415 having opposite polarity. The conductors 413, 415 may be connected to a power source. In this configuration, a resistor R3, R5 is formed between each of the LED chips in the first and second clusters, respectively. Also, a resistor R4 is formed between the clusters of LED chips, the clusters being connected in parallel. The resistors R3, R4, R5 are formed by the resistive characteristics of the first top substrate 409.

Although only four LED chips are illustrated, it will be appreciated from the above discussion that additional LED chips can be added and connected in parallel.

Accordingly, in the light active sheet material, the pattern of LED chips can include two or more LED chips electrically connected in parallel, wherein adjacent connected LED chips are biased opposite of each other. Moreover, a first portion of the pattern of conductors below and in electrical communication with one of the LED chips is spaced apart from a second portion of the pattern of conductors below and in electrical communication with the other of the at least two LED chips which are electrically connected in parallel.

Referring now to FIG. 5, a schematic diagram corresponding to FIG. 4 will be discussed and described. The LED chips 5, 6, 7, 8 are biased opposite of each other, and connected in parallel. The LED chips 5, 6, 7, 8 are connected to each other through resistors R3, R4, R5.

Referring now to FIG. 6A to FIG. 6E, cross sectional diagrams illustrating a method of producing the light sheet according to FIG. 4 will be discussed and described. In FIG. 6A, conductors 613, 615 are disposed on a bottom substrate 617. The conductor has a pattern corresponding to locations where the LED chips will be patterned. The conductors 613, 615 correspond to the conductors discussed in connection with FIG. 4.

In FIG. 6B, a non-conductive adhesive 611 is disposed on the bottom substrate 617 and conductors 613, 615. The adhesive 611 corresponds to the adhesive discussed in connection with FIG. 4.

As illustrated in FIG. 6C, the LED chips 5, 6, 7, 8 are provided on the adhesive 611 in a predetermined pattern to correspond to the conductors 613, 615.

FIG. 6D illustrates an ITO layer 609, corresponding to the first top substrate discussed in FIG. 4, previously disposed on a transparent substrate 607, corresponding to the second top substrate discussed in FIG. 4. Both the ITO layer 609 and the transparent substrate 607 are disposed over the LED chips 5, 6, 7, 8.

As illustrated in FIG. 6E, the transparent substrate 607 and the ITO layer 609 are disposed on top of the LED chips 5, 6, 7, 8. A roller presses together the transparent substrate 607, ITO layer 609, adhesive layer 611, LED chips 5, 6, 7, 8, conductors 613, 615, and the bottom substrate 617. By use of pressure and/or heat, the LED chips can be sandwiched between the conductors 613, 615 and ITO layer 609 so as to be in electrical contact. Meanwhile, the non-conductive adhesive 611 becomes distributed in the gaps between the conductors 613, the gaps between the conductors 613 and the ITO layer 609, the gaps between the bottom substrate 617 and the ITO layer 609, and the gaps between the LED chips 5, 6, 7, 8.

FIG. 7 and FIG. 8 illustrate a light sheet utilized in a lamp housing with a lens. In FIG. 7, a light sheet is used in place of a conventional PCB LED assembly, sometimes referred to as a “surface mounted device” (SMD) panel. In FIG. 8, a light sheet is sized to fit in the lens. The light sheet referred to in FIGS. 7 and 8 can advantageously be implemented as, for example, the light sheet described in connection with FIG. 1, FIG. 4, or other light sheet appropriately arranged.

Referring now to FIG. 7, an exploded view of a lamp with a light sheet assembled on a lamp housing will be discussed and described. A lamp 701 includes a housing 703, a lens 705, and a light sheet 707. The low cost and small space for the required number of LED chips in the light sheet 707 allows for the lamp 701 to provide a wide area of illumination.

The light sheet 707 can be mounted on or adhered to the housing 703, independently of the lens 705. The light sheet 707 is oriented on the housing 703 so that the LED chips in the light sheet 707 are directed toward the lens 705, thereby allowing light emitted from the LED chips to pass through the lens 705.

The lens 705 can be clear, thereby relying on the color of the light sheet 707 to provide color. The light sheet 707 optionally can include color LED chips, colored substrates, and/or colored adhesive.

Optionally, multiple light sheets can be used. Each light sheet can provide a different path which electrical current can take. Accordingly, a printed circuit board (not illustrated) can provide a control which can selectively illuminate one or more of the multiple light sheets. Various effects can be provided, for example, a flashing effect, a flashing light that changes colors, a rotating light, and the like.

Optionally, a multi-layered light sheet can be used in a lamp with a double-face. Double face lamps requiring a different color on each side can use multiple light sheets and/or a multi-colored light sheet. Optionally, the light sheet 707 can include color LED chips, and a colored lens can be coordinated to allow only one color through.

The lamp 701 utilizing a light sheet 707 can be mounted directly onto a vehicle. Such lamps 701 can be used as marker lamps, dome lamps, high mount stop lamps (HMSL), center high mount stop lamps (CHMSL), stop/tail/turn (STT) lights, front/park/turn (FPT) lights, fog lamps, headlamps, and the like.

The light sheet 707 can be electrically connected to an electrical harness of the conveyance via a connection (not shown) disposed in the housing 703.

The light sheet 707 can be removed and replaced by dismounting the lens 705 from the housing 703, removing the light sheet 707 from the housing 703, placing a new light sheet 707 on the housing 703 (as described above), and re-mounting the lens 705 onto the housing 703.

Referring now to FIG. 8, an exploded view of a lamp with a light sheet assembled on a back of a lens will be discussed and described. A lamp 801 includes a housing 809, a lens 803, a light sheet 805, and an electrical connector 807. The lens 803 is removably mounted on the housing 809, in accordance with various conventional techniques.

The light sheet 805 can be sized with the same perimeter as the lens 803, so that the light sheet 805 can be placed in, attached to, or adhered to the lens 803. Because the light sheet 805 can be flexible and can have the same perimeter as the lens 803, the tension of the light sheet 805 within the lens 803 can be sufficient to maintain the desired position of the light sheet 805 within the lens 803. Alternatively, the light sheet 805 can be adhered to or mounted on the lens 803.

The light sheet 805 is oriented in the lens 803 so that the LED chips are directed toward the lens 803, thereby allowing light emanating from the LED chips to pass through the lens 803. The lens 803 with the light sheet 805 thereon can be mounted on the housing 809.

The light sheet 805 can be readily removed and replaced by dismounting the lens 803 from the housing 809, removing the light sheet 805 from the lens 803, placing a new light sheet 805 on the lens 803 (as described above), and re-mounting the lens 803 onto the housing 809.

As described in connection with FIG. 7, the lens 803 can be clear or of various colors, and the light sheet 805 can be clear or have various color LED chips and/or colored substrates and/or adhesive.

The lamp 801 utilizing a light sheet 805 can be mounted directly onto a vehicle. Such lamps 801 can be used as marker lamps, dome lamps, high mount stop lamps (HMSL), center high mount stop lamps (CHMSL), stop/tail/turn (STT) lights, front/park/turn (FPT) lights, fog lamps, headlamps, and the like.

The light sheet 805 can be electrically connected to an electrical harness of the conveyance via a connection 807 to the light sheet 805.

Accordingly, a lamp can include a light active sheet material, a housing, and a lens mounted on the housing. The light active sheet material can include a transparent electrically conductive top substrate; a pattern of at least one light emitting diode (LED) chip sandwiched between a bottom substrate and the top substrate; and a non-conductive transparent adhesive material disposed between the bottom substrate, the at least one LED chip, and the top substrate. The at least one LED chip is preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the bottom substrate. The light active sheet material can be disposed on the housing or the lens, the transparent electrically conductive top substrate facing the lens and the bottom substrate facing the housing, such that light from the at least one LED chip travels through the lens.

The lamp can be configured to be attached to a conveyance. A connector can extend from the positive and negative conductors of the light sheet, respectively, the connector configured to be electrically connected outside the light active sheet material to an electrical wiring harness of a conveyance.

Furthermore, a method of providing a light source in a lamp can include providing a light active sheet material; removing a lens separably mounted on a housing; and disposing the light active sheet material (such as described above) on the housing or the lens. The method can further include electrically connecting the electrical connector to an electrical wiring harness of the conveyance.

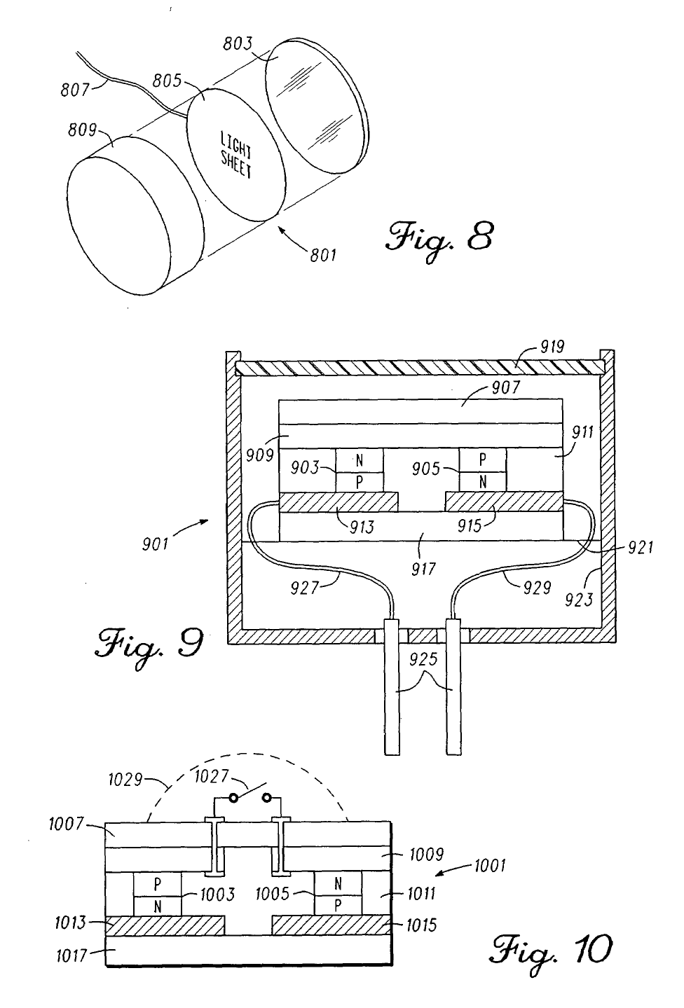

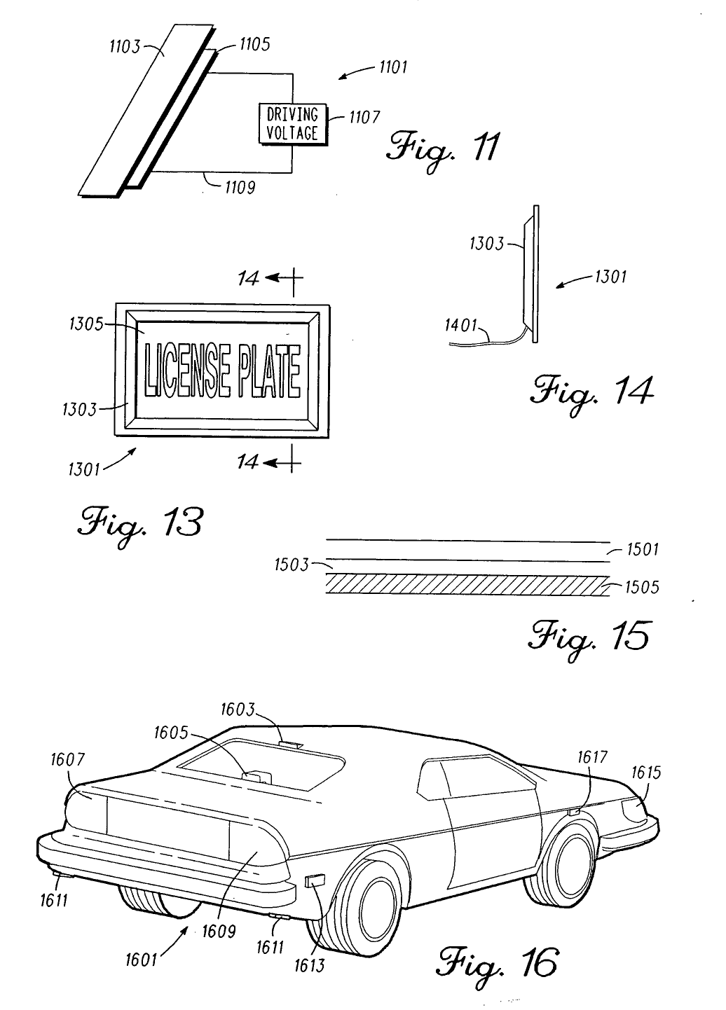

FIG. 9 and FIG. 10 illustrate two different variations of an illuminated push button utilizing a light sheet. The light sheet is sufficiently thin to be mounted on or in a push button. FIG. 9 illustrates a push-button with a diffusing material as the button face, whereas FIG. 10 is a partial illustration of a variation of a push button that has a force-activated light sheet. The light sheet referred to in FIGS. 9 and 10 can advantageously be implemented as, for example, the light sheet described in connection with FIG. 1, FIG. 4, or any other light sheet appropriately arranged.

Referring now to FIG. 9, a cross section of a backlit push button will be discussed and described. The push button 901 includes a base portion 923, a mounting portion 921, and a face portion 919, and may include other functionality (not illustrated) as will be understood by one familiar with push button technology.

Also included in the push button 901 is a light sheet, to provide illumination. In this illustration, the light sheet is represented by a transparent top substrate 907, a transparent and electrically conductive top substrate (such as the illustrated ITO substrate 909), LED chips (represented here by LED chips 903, 905), conductors 913, 915, and bottom substrate 917.

An electrical connector 925 is mounted on the base portion 923, and the conductors 913, 915 of the light sheet can be electrically connected to the electrical connector 925 via respective connectors 927, 929. In this illustration, the electrical connector 925 is represented as a conventional double male electrical connector, and the connectors 927, 929 are wires. Other types of known electrical connectors can be substituted.

The push button can take the form of a conventional push button. The base portion 923 can be formed in a hollow shape. The mounting portion 921 can be disposed inside the base portion 923, and configured at a desired height to support the light sheet.

The face portion 919 forming a face of the button can be made of a transparent or translucent material, for example a diffusing plastic.

The light sheet is mounted on or adhered to the mounting portion 921 so that the LED chips 903, 905 are directed toward the face portion 919, thereby allowing light emanating from the LED chips to pass through the face portion 919. Consequently, the push button can be illuminated. The use of light active sheet material avoids having to position multiple individual LED chips under a plastic front, as is done with conventional technology.

Accordingly, an illuminated push button can include a light active sheet material, and a base portion. The light active sheet material can include a transparent electrically conductive top substrate; a pattern of one or more light emitting diode (LED) chips sandwiched between a bottom substrate and the top substrate; and a non-conductive transparent adhesive material disposed between the bottom substrate, the LED chips, and the first top substrate. The LED chips are preformed before being patterned in the light active sheet material as an unpackaged discrete semiconductor device having an anode p-junction side and a cathode n-junction side. Either of the anode and the cathode side of the LED chip is in electrical communication with the top substrate and the other of the anode and the cathode side is in electrical communication with the bottom substrate. The light active sheet material is mounted on the base portion, the top substrate facing away from the base portion, such that light from the at least one LED chip travels away from the base portion.

Accordingly, in the illuminated push button, the base portion can be configured to be mounted on a conveyance. Also, a connector can extend from the positive and negative conductors of the light sheet, respectively, the connector configured to be electrically connected outside the light active sheet material to an electrical wiring harness of the conveyance.

Furthermore, the illuminated push button can include a face portion mounted on the base portion, wherein the face portion is formed of a transmissivity diffusing material, the transparent electrically conductive top substrate facing the face portion, such that light from the at least one LED chip travels through the face portion.

Accordingly, there is also provided a method of making an illuminated push button. A light active sheet material is provided. The light active sheet material (described above) is mounted on a base portion, the top substrate facing away from the base portion, such that light from the at least one LED chip travels away from the base portion. Also, the light active sheet material can include a connector extending therefrom, and the base portion can be configured to be attached to a conveyance; the electrical connector can be electrically connected to an electrical wiring harness of the conveyance.

The method can include mounting a face portion on the base portion, the face portion being formed of a transmissivity diffusing material, the transparent electrically conductive top substrate facing the face portion, such that light from the at least one LED chip travels through the face portion.

Referring now to FIG. 10, a partial cross section of another backlit push button will be discussed and described. In comparison with the push button illustrated in FIG. 9, this version of a backlit push button 1001 omits the face portion 919, but includes a light sheet having a collapsible dome 1029. FIG. 10 illustrates a portion of the light sheet having the collapsible dome.

The light sheet includes a transparent top substrate (such as the illustrated PEN substrate) 1007, a transparent and electrically conductive top substrate (such as the illustrated ITO substrate 1009), LED chips (represented here by LED chips 1003, 1005), conductors 1013, 1015, and bottom substrate 1017.

The dome 1029 is created in the transparent top substrate 1007, to incorporate a switch 1027 formed in accordance with known techniques, for example using 2X conductive ink. Membrane switches are described, for example, in U.S. Pat. No. 4,618,754 and U.S. Pat. No. 5,561,278, expressly incorporated herein. A membrane switch can be configured to be either normally open or normally closed.

When the button is pressed, the dome 1029 collapses temporarily and contacts the switch 1027 or otherwise makes contact with a conductor, thus completing the circuit. Alternatively, an activating force on the dome 1029, for example, a force applied by a finger, can cause the electrical circuit that is normally completed to be opened. When force is removed, the electrical circuit is completed, and thus returns to its original state.

Accordingly, the light active sheet material can further include a top sheet having a transparent dome disposed on a side of the transparent electrically conductive top substrate opposite to the at least one LED chip, the transparent dome being temporarily collapsible so that the electrically conductive top substrate contacts the at least one LED chip when the dome is collapsed, wherein a circuit including the at least one LED chip is completed when the dome is collapsed, and the circuit is interrupted when the dome is not collapsed. Furthermore, the transparent electrically conductive top substrate can be mounted such that the transparent dome is an exterior layer of the illuminated push button.

In this illustration, the light is normally on without an activating force. Similar techniques can be used so that the light is normally off without an activating force.

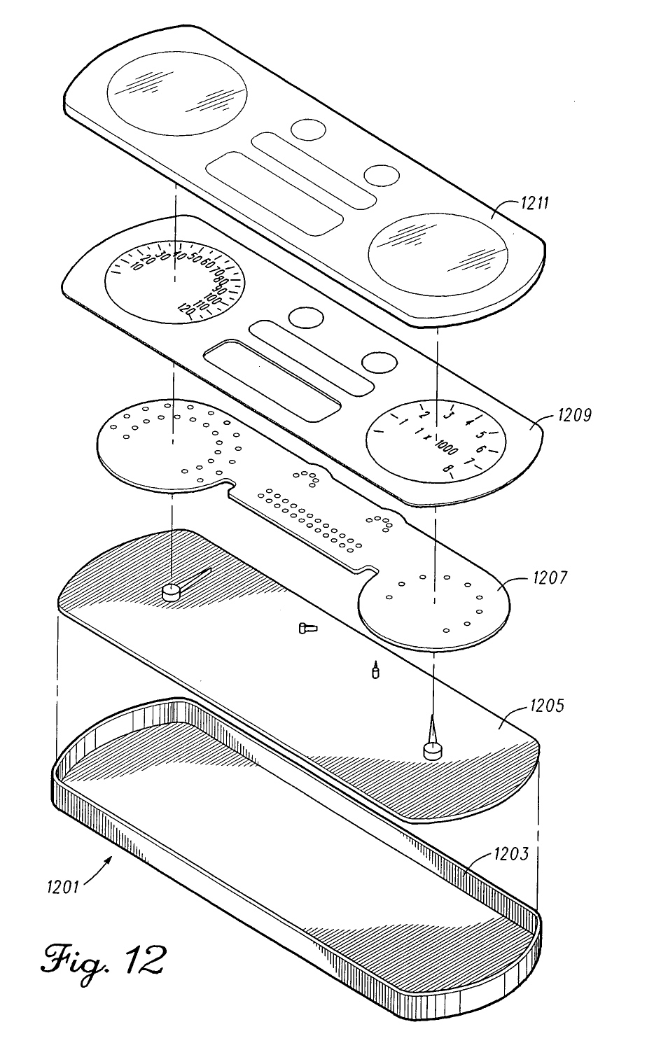

FIG. 11 and FIG. 12 respectively illustrate a side view and an exploded view of an instrument cluster utilizing a light sheet to provide backlighting. The size and profile of the instrument cluster can be reduced because the light sheet is flat and can be placed right behind a surface to achieve the desired illumination, as opposed to at the bottom of a deep cup. In addition, the use of light sheet can reduce the weight of the instrument cluster. The light sheet referred to in FIGS. 11 and 12 can advantageously be implemented as, for example, the light sheet described in connection with FIG. 1, FIG. 4, or any other light sheet appropriately arranged.

Referring now to FIG. 11, a side view of a backlit instrument cluster will be discussed and described. The instrument cluster 1101 can include an instrument cluster assembly 1103, and a light active sheet material 1105. Further details about an exemplary instrument cluster assembly using light active sheet material are provided in FIG. 12.

The light active sheet material 1105 in the instrument cluster 1101 can be electrically connected via connectors 1109 to a power source, such as the illustrated driving voltage 1107. The driving voltage 1107 can be provided from the electrical harness of a conveyance in which the instrument cluster is mounted.

Referring now to FIG. 12, an exploded view of a backlit instrument cluster will be discussed and described. An instrument cluster 1201 for a conveyance includes a lens mask assembly 1211, an appliqué 1209 disposed behind the lens mask assembly, a housing 1203, a light active sheet material 1207, and a printed circuit board 1205 mounted behind the light active sheet material 1207.

The lens mask assembly 1211 provides an outer layer of the instrument cluster 1201, and is intended to face a driver inside the conveyance.

The appliqué 1209 has translucent graphical information and an optically transmissive diffusion material, which can be adhered to a side disposed away from a driver of the conveyance, in accordance with conventional techniques.

The light sheet includes LED chips patterned to be located to backlight the appliqué 1209, for example, behind gauge and warning graphics on the appliqué 1209. The LED chips, the transparent substrates, and/or the adhesive included in the light sheet can include various colors and/or can be clear.

The printed circuit board 1205 is configured with printed electronics to selectively address and selectively drive the light active sheet material, and can be mounted behind the light active sheet material 1207. The printed circuit board 1205 can be provided in accordance with conventional techniques, and can include for example general output pins and/or PWM (pulse width modulation) channels from a microcontroller to selectively drive the light active sheet material; the addressing of the pins/channels can be controlled by hardware and/or software included in the microcontroller.

The housing 1203 can be configured to house the lens mask assembly 1211, the appliqué 1209, the light active sheet material 1207, and the printed circuit board 1205. The printed circuit board 1205, the light active sheet material 1207, the appliqué 1209, and the lens mask assembly 1211 can be layered on the housing 1203, in that order.

Accordingly, an illuminated instrument cluster for a conveyance can include a lens mask assembly; an appliqué disposed behind the lens mask assembly, having translucent graphical information and an optically transmissive diffusion material adhered to a side disposed away from a driver of the conveyance; a housing; a light active sheet material; and a printed circuit board configured to address and drive the light active sheet material, mounted behind the light active sheet material. The light active sheet material can include a transparent electrically conductive top substrate; a pattern of light emitting diode (LED) chips sandwiched between a bottom substrate and the top substrate; and a non-conductive transparent adhesive material disposed between the bottom substrate, the LED chips, and the first top substrate, wherein the LED chips are preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the bottom substrate, wherein the light active sheet material is mounted behind the appliqué, the top substrate facing toward the appliqué, such that light from the LED chips travels through the graphical information of the appliqué. The lens mask assembly, the appliqué, the light active sheet material, and the printed circuit board can be mounted in the housing in that order.

Furthermore, in the illuminated instrument cluster, the LED chips can have red, white, amber, blue, or green colors (or a combination of two or more colors). The color of LED chips in the pattern can be disposed in a pattern corresponding to the graphical information of the appliqué.

In addition, the instrument cluster can be configured to be mounted in a conveyance. A connector can extend from the positive and negative conductors of the light sheet, respectively, the connector configured to be electrically connected outside the light active sheet material to an electrical wiring harness of a conveyance.

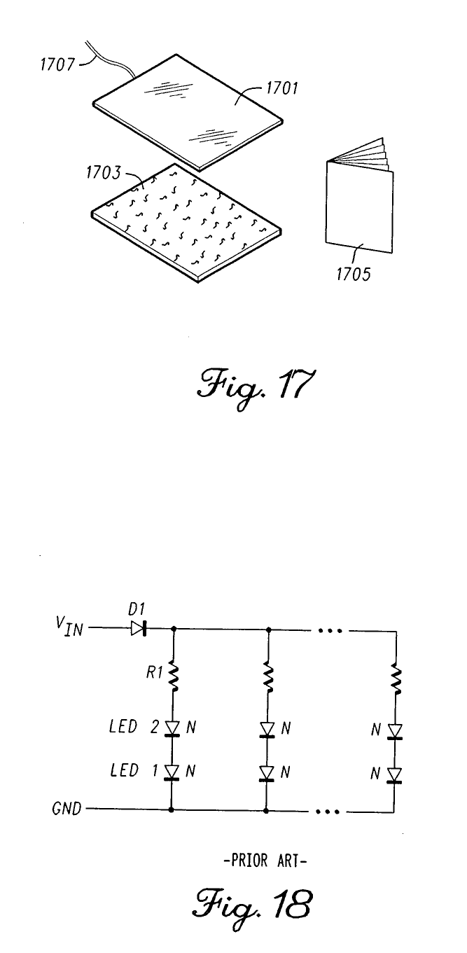

The light sheet can also be used with a license plate frame, so as to emit light at an angle on the license plate. FIG. 13, FIG. 14 and FIG. 15 illustrate the use of a light sheet with a license plate frame, with FIG. 13 being a front view, FIG. 14 being a partial side view, and FIG. 15 being a partial cross section to illustrate the layers. The light sheet referred to in FIG. 13 to FIG. 15 can advantageously be implemented as, for example, the light sheet described in connection with FIG. 1, FIG. 4, or other light sheet appropriately arranged.

Referring now to FIG. 13, a front view of an illuminated license plate frame will be discussed and described. An illuminated license plate frame can include a license plate frame 1301, a light active sheet material 1303, and an opening for framing a license plate 1305 which can be mounted therein. The license plate frame is intended to be mounted on a conveyance.

The license plate frame 1301 can be made in accordance with conventional techniques. The light active sheet material 1303 can advantageously be implemented as, for example, the light sheet described in connection with FIG. 1, FIG. 4, or other light sheet appropriately arranged. The light active sheet material 1303 is mounted on or adhered to the inside of the license plate frame which is angled toward the license plate 1305.

Referring now to FIG. 14, a partial side view of FIG. 13 will be discussed and described. The license plate frame 1301 can have the shape of a conventional license plate frame and generally includes an inside facing surface angled toward the license plate, as well as a planar portion which is parallel to a plane of the license plate to be mounted in the license plate frame.

The light active sheet material 1303 can be adhered to or mounted on the inside facing surface of the license plate frame, with the LED chips in the light active sheet material directing light away from the inside facing surface, so as to direct light toward an inside of the license plate frame and to a license plate mounted therein. The light active sheet material 1303 can be electrically connected by a connector 1401 to the electrical harness (not illustrated) of a conveyance to which the license plate frame 1301 is attached.

Referring now to FIG. 15, a partial cross section of FIG. 13 will be discussed and described. The light active sheet material 1501 can be mounted on the license plate 1505 by an adhesive 1503. The light active sheet material 1501 is arranged so that the LED chips in the light active sheet material 1501 direct light away from the license 1505. Consequently, light sheet can be placed on the inside of a license plate frame so as to emit light at an angle on the license plate.

Accordingly, an illuminated license plate frame for use with a license plate can include a light active sheet material; and a license plate frame configured to have a license plate mounted therein. The light active sheet material comprises a transparent electrically conductive top substrate, and a pattern of at least one light emitting diode (LED) chip sandwiched between a bottom substrate and the top substrate, wherein the at least one LED chip is preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the bottom substrate. The light active sheet material can be mounted on an inside facing surface of the license plate frame facing an inside of the license plate frame, the top substrate facing away from the inside facing surface, such that light from the at least one LED chip travels toward a license plate mounted in the license plate frame.

Moreover, in the illuminated license plate frame, the license plate frame can be configured to be mounted on a conveyance, and the light active sheet material can include a connector extending therefrom, the connector configured to be electrically connected outside the light active sheet material to an electrical wiring harness of the conveyance.

Accordingly, there is also a method of making an illuminated license plate frame. The method can include providing a light active sheet material (such as described above); and mounting the light active sheet material on a license plate frame configured to have a license plate mounted therein. The method can include electrically connecting the electrical connector to an electrical wiring harness of the conveyance.

Referring now to FIG. 16, various configurations of a light sheet applied directly to an automobile 1601 will be discussed and described. A light sheet can be used for interior and/or exterior lighting, including center high mount stop lamps (CHMSL) 1603, dome lamps, high mount stop lamp (HMSL) 1605, headlamps and/or fog lamps, stop/tail/turn (STT) lights 1607, 1609, under-mount illumination 1611, marker lamps 1613, 1617, front/park/turn (FPT) lights 1615, strobe lights, and the like, used in connection with conveyances.

The light sheet can be provided in a variety of colors, as described above. The light sheet can be trimmed to a predetermined size appropriate for use as the desired interior or exterior lighting. The light sheet can be applied directly to the conveyance, such as the automobile 1601, using adhesive.

Accordingly, a lighting system for a conveyance can include a light active sheet material; and an adhesive disposed on the light active sheet material. The light active sheet material can include top and bottom electrically conductive substrates, and a pattern of light emitting diode (LED) chips sandwiched between the electrically conductive substrates, wherein the top electrically conductive substrate is transparent, wherein the LED chips are preformed before being patterned in the light active sheet material as an unpackaged discrete semiconductor device having an anode p-junction side and a cathode n-junction side, wherein either of the anode and the cathode side is in electrical communication with one of the electrically conductive substrates and the other of the anode and the cathode side is in electrical communication with the other of the electrically conductive substrates. Accordingly, the light active sheet material can be formed as lighting for a conveyance.

Moreover, one or more embodiments provide that the LED chips have red or white or amber or blue or green colors (or a combination of two or more of the colors). The color of LED chips in the pattern can be disposed in a pattern for use as one or more lighting devices. The lighting devices can be a head light, a rear light, a rear window light, a side window light, a turn signal light, a high mount stop light, a side marker lamp, an under-mount lamp, an interior ambient light, or an emergency strobe light.

In addition, the light active sheet material is formed to be attached to a frame or a body panel disposed on an automotive vehicle. Mounting the lighting system can further include attaching the lighting system to the frame or the body panel.

Further accordingly, a method of providing a conveyance with a lighting system includes providing a lighting system; mounting the lighting system on the conveyance; and electrically connecting the lighting system to an electrical wiring harness of the conveyance. The lighting system includes a light active sheet material.

The light active sheet material can include a transparent electrically conductive top substrate, and a pattern of at least one light emitting diode (LED) chip sandwiched between a bottom substrate and the top substrate, wherein the at least one LED chip is preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the bottom substrate.

Also, the light active sheet material can further include a pattern of conductors patterned on the bottom substrate. There can be plural LED chips including the at least one LED chip included in the pattern of LED chips. The pattern of LED chips can be disposed between the top substrate and the bottom substrate on a side with the pattern of conductors, wherein the other of the anode and the cathode side is in electrical communication with the pattern of conductors on the bottom substrate, wherein conductors in the pattern of conductors are spaced apart.

Referring now to FIG. 17, a kit for use in connection with applying a light sheet to a conveyance will be discussed and described. The kit includes a light active sheet material 1701, an adhesive sheet 1703, and instructions 1705.

The light active sheet material 1701 can be provided in the predetermined size appropriate for the interior or exterior lighting, or can be provided ready to be trimmed to the predetermined size. The light active sheet material can be provided in various colors, as discussed above, for example, red, white, amber, blue, or green, and/or combinations of two or more of the various colors. The light active sheet material 1701 can advantageously be implemented as, for example, the light sheet described in connection with FIG. 1, FIG. 4, or any other light sheet appropriately arranged.

The light active sheet material 1701 can be provided with a connector 1707, connected to and extending from the conductor of the light sheet as explained in more detail above. The connector 1707 can be configured to be electrically connected to an electrical harness of the conveyance.

The adhesive sheet can have a size which corresponds to a size of the light active sheet material 1701, or can be provided ready to be trimmed to a size such as the predetermined size.

The instructions can include information on shaping the light active sheet material 1701 and the adhesive 1703, and on attaching the light active sheet material 1701 to a conveyance. For example, the instructions can provide appropriate sizes, appropriate locations, and appropriate colors of the light active sheet material 1701 and the adhesive 1703, for various types of interior and exterior lighting.

The light active sheet material can be electrically connected by the connector 1707 to an electrical harness (not illustrated) of a conveyance to which the light active sheet material 1701 is attached. The instructions can include information on electrically connecting the connector 1707 to the electrical harness.

Accordingly, a lighting system kit for attaching a transparent light sheet to a conveyance can include a light active sheet material; an adhesive sheet for attaching the light active sheet material to the conveyance, wherein the adhesive sheet has a size sufficient to attach the light active sheet material to the conveyance; and instructions for shaping the light active sheet material and attaching the light active sheet material to the conveyance. The light active sheet material can include a transparent electrically conductive top substrate, and a pattern of at least one light emitting diode (LED) chip sandwiched between a bottom substrate and the top substrate, wherein the at least one LED chip is preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the bottom substrate.

In the lighting system kit, the light active sheet material can be formed as a lighting system for an automobile or a truck. Also, the LED chips can have red, white, amber, blue, or green colors (or a combination of two or more of the colors), and the color of LED chips in the pattern can be disposed in a pattern for use as one or more lighting devices. Such the lighting devices can be a head light, a rear light, a rear window light, a side window light, a turn signal light, a high mount stop light, a side marker lamp, an under-mount lamp, or an emergency strobe light.

It should be noted that the term conveyance is used herein to indicate something which serves as a means of transportation. Examples of conveyances, as the term is used herein, include automobiles, trucks, buses, other motorized land vehicles such as ride-on lawn mowers, trains, air craft, water craft, heavy machinery used for regulated or non-regulated industries such as agricultural, lawn care, mining, snow blowing, trailers for use with the foregoing, and the like, and variants or evolutions thereof.

An LED chip utilized with the light active material can be organic (OLED) or inorganic (ILED), although testing shows that ILED chips are particularly preferable. Appropriate OLED and ILED chips are readily available from many manufacturers.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An illuminated push button, comprising:
a light active sheet material; and
a base portion,
wherein the light active sheet material comprises a transparent electrically conductive top substrate; a pattern of at least one light emitting diode (LED) chip sandwiched between a bottom substrate and the top substrate; and a non-conductive transparent adhesive material disposed between the bottom substrate, the LED chips, and the first top substrate,
wherein the at least one LED chip is preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the bottom substrate,
wherein the light active sheet material is mounted on the base portion, the top substrate facing away from the base portion, such that light from the at least one LED chip travels away from the base portion.

2. The illuminated push button of claim 1,
wherein the base portion is configured to be mounted on a conveyance,
wherein the light active sheet material further includes a connector extending therefrom, the connector configured to be electrically connected outside the light active sheet material to an electrical wiring harness of the conveyance.

3. The illuminated push button of claim 1, further comprising a face portion mounted on the base portion,
wherein the face portion is formed of a transmissivity diffusing material, the transparent electrically conductive top substrate facing the face portion, such that light from the at least one LED chip travels through the face portion.

4. The illuminated push button of claim 1, wherein the light active sheet material further comprises a top sheet having a transparent dome disposed on a side of the transparent electrically conductive top substrate opposite to the at least one LED chip, the transparent dome being temporarily collapsible so that the electrically conductive top substrate contacts the at least one LED chip when the dome is collapsed, wherein a circuit including the at least one LED chip is completed when the dome is collapsed, and the circuit is interrupted when the dome is not collapsed.

5. A method of making an illuminated push button, comprising:
providing a light active sheet material; and
mounting the light active sheet material on a base portion,
wherein the light active sheet material comprises a transparent electrically conductive top substrate; a pattern of at least one light emitting diode (LED) chip sandwiched between a bottom substrate and the top substrate; and a non-conductive transparent adhesive material disposed between the bottom substrate, the LED chips, and the first top substrate,
wherein the at least one LED chip is preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the bottom substrate,
wherein the light active sheet material is mounted on the base portion, the top substrate facing away from the base portion, such that light from the at least one LED chip travels away from the base portion.

6. The method of claim 5, wherein the light active sheet material further includes a connector extending therefrom, and the base portion is configured to be attached to a conveyance, further comprising electrically connecting the electrical connector to an electrical wiring harness of the conveyance.

7. The method of claim 5, further comprising mounting a face portion on the base portion,
wherein the face portion is formed of a transmissivity diffusing material, the transparent electrically conductive top substrate facing the face portion, such that light from the at least one LED chip travels through the face portion.

8. The method of claim 5, wherein the light active sheet material further comprises a top sheet having a transparent dome disposed on a side of the transparent electrically conductive top substrate opposite to the at least one LED chip, the transparent dome being temporarily collapsible so that the electrically conductive top substrate contacts the at least one LED chip when the dome is collapsed, wherein a circuit including the at least one LED chip is interrupted when the dome is collapsed, and the circuit is completed when the dome is not collapsed.

9. The method of claim 8, wherein the transparent electrically conductive top substrate is mounted such that the transparent dome is an exterior layer of the illuminated push button.

10. An illuminated instrument cluster for a conveyance, comprising:
a lens mask assembly;
an appliqué disposed behind the lens mask assembly, having translucent graphical information and an optically transmissive diffusion material adhered to a side disposed away from a driver of the conveyance;
a housing;
a light active sheet material; and
a printed circuit board configured to address and drive the light active sheet material, mounted behind the light active sheet material,
wherein the light active sheet material comprises a transparent electrically conductive top substrate; a pattern of light emitting diode (LED) chips sandwiched between a bottom substrate and the top substrate; and a non-conductive transparent adhesive material disposed between the bottom substrate, the LED chips, and the first top substrate,
wherein the LED chips are preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the bottom substrate,
wherein the light active sheet material is mounted behind the appliqué, the top substrate facing toward the appliqué, such that light from the LED chips travels through the graphical information of the appliqué,
wherein the lens mask assembly, the appliqué, the light active sheet material, and the printed circuit board are mounted in the housing in that order.

11. The illuminated instrument cluster of claim 10,
wherein the LED chips have red or white or amber or blue or green colors,
wherein the color of LED chips in the pattern are disposed in a pattern corresponding to the graphical information of the appliqué.

12. The illuminated instrument cluster of claim 10,
wherein the instrument cluster is configured to be mounted in a conveyance,
wherein the light active sheet material further includes a connector extending therefrom, the connector configured to be electrically connected outside the light active sheet material to an electrical wiring harness of the conveyance.

13. A lighting system for a conveyance, comprising:
a light active sheet material;
an adhesive disposed on the light active sheet material,
wherein the light active sheet material comprises top and bottom electrically conductive substrates, and a pattern of light emitting diode (LED) chips sandwiched between the electrically conductive substrates,
wherein the top electrically conductive substrate is transparent,
wherein the LED chips are preformed before being patterned in the light active sheet material as an unpackaged discrete semiconductor device having an anode p-junction side and a cathode n-junction side,
wherein either of the anode and the cathode side is in electrical communication with one of the electrically conductive substrates and the other of the anode and the cathode side is in electrical communication with the other of the electrically conductive substrates,
wherein the light active sheet material is formed as lighting for a conveyance.

14. The lighting system of claim 13,
wherein the LED chips have red or white or amber or blue or green colors, and
wherein the color of LED chips in the pattern are disposed in a pattern for use as one or more lighting devices,
wherein the lighting devices are: a head light, a rear light, a rear window light, a side window light, a turn signal light, a high mount stop light, a side marker lamp, an under-mount lamp, an interior ambient light, or an emergency strobe light.

15. The lighting system of claim 13, wherein the light active sheet material is formed to be attached to a frame or a body panel disposed on an automotive vehicle.

16. A method of providing a conveyance with a lighting system, comprising:
providing a lighting system;
mounting the lighting system on the conveyance; and
electrically connecting the lighting system to an electrical wiring harness of the conveyance,
wherein the lighting system includes a light active sheet material,
wherein the light active sheet material comprises a transparent electrically conductive top substrate, and a pattern of at least one light emitting diode (LED) chip sandwiched between a bottom substrate and the top substrate,
wherein the at least one LED chip is preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the bottom substrate.

17. The method of claim 16, wherein lighting system is formed to be attached to a frame disposed on the conveyance, wherein the mounting further includes attaching the lighting system to the frame.

18. The method of claim 16, wherein the light active sheet material further comprises:
a pattern of conductors patterned on the bottom substrate;
wherein there are plural LED chips including the at least one LED chip included in the pattern of LED chips,
wherein the pattern of LED chips is disposed between the top substrate and the bottom substrate on a side with the pattern of conductors,
wherein the other of the anode and the cathode side is in electrical communication with the pattern of conductors on the bottom substrate,
wherein conductors in the pattern of conductors are spaced apart.

19. A lighting system kit for attaching a transparent light sheet to a conveyance, comprising:
a light active sheet material;
an adhesive sheet for attaching the light active sheet material to the conveyance,
wherein the adhesive sheet has a size sufficient to attach the light active sheet material to the conveyance; and
instructions for shaping the light active sheet material and attaching the light active sheet material to the conveyance,
wherein the light active sheet material comprises wherein the light active sheet material comprises a transparent electrically conductive top substrate, and a pattern of at least one light emitting diode (LED) chip sandwiched between a bottom substrate and the top substrate,
wherein the at least one LED chip is preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the bottom substrate.

20. The lighting system kit of claim 19,
wherein the light active sheet material is formed as a lighting system for an automobile or a truck,
wherein the LED chips have red or white or amber or blue or green colors,
wherein the color of LED chips in the pattern are disposed in a pattern for use as one or more lighting devices,
wherein the lighting devices are: a head light, a rear light, a rear window light, a side window light, a turn signal light, a high mount stop light, a side marker lamp, an under-mount lamp, or an emergency strobe light.
